(19) United States
(12) Patent Application Publication
(10) Pub. No.: US 2026/0219016 A1
(43) Pub. Date: Jul. 30, 2026

(54) ILLUMINATED NOCK

(71) Applicant: Howard Andrew BUCHANAN, Burnsville, NC (US)

(72) Inventor: Howard Andrew BUCHANAN, Burnsville, NC (US)

(21) Appl. No.: 19/461,341

(22) Filed: Jan. 27, 2026

Related U.S. Application Data
(60) Provisional application No. 63/750,072, filed on Jan. 27, 2025.

(51) Int. Cl. F42B 12/38; F21V 23/02; F21V 23/04; F21V 33/00; F21W 131/40; F21Y 115/10; F42B 6/06

(52) U.S. Cl. CPC F42B 12/382; F21V 23/023; F21V 23/04; F21V 33/00; F42B 6/06; F21W 2131/40; F21Y 2115/10

(57) ABSTRACT

A nock assembly is configured to engage a bowstring of a bow or crossbow and includes a light device, an actuator member, and a detent system. The light device is configured to selectively illuminate a nock and includes a switch member that is movable between an on position and an off position. The detent system resists movement of the switch member between the on and off positions. The actuator member is positioned to transfer force from the bowstring to the switch member to move the switch member from the off position to the on position when the bowstring is released from a drawn position, such that the release of the bowstring causes the nock to be illuminated.

### BACKGROUND OF THE INVENTION

Hunters often use arrows or crossbow bolts when hunting game. When the arrow or bolt is released and travels toward a target animal, it is helpful for the archer to view the flight path of the arrow or bolt and where it impacts the target animal. Arrows having nocks that are illuminated are sometimes employed. Illuminated nocks enhance the visibility of the arrow during flight and may aid in the tracking and retrieval of the animal if the animal moves after impact.

Prior art illuminated nocks typically include a battery and a light-emitting diode (LED) or other light-emitting device such as a small incandescent bulb. Although illuminated nocks may greatly assist hunters, prior art illuminated nocks have several drawbacks. To prevent the battery from being depleted, illuminated nocks must be kept “off,” i.e., the LED must be electrically disconnected from the battery during storage. Accordingly, with many prior art illuminated nocks, a hunter must take the time to manipulate the nock to electrically connect the LED to the battery.

A hunter may lose the opportunity to take a shot at the target animal due to the time required to turn the LED on. Furthermore, the additional movement required to turn the LED on, or the LED itself, may alert the target animal to the presence of the hunter.

### SUMMARY

A nock assembly for engagement with the bowstring of a bow or crossbow includes a light device configured to selectively illuminate the nock. The light device includes a switch member that is movable between an on position and an off position. An actuator member is positioned to transfer force from the bowstring to the switch member to move the switch member from the off position to the on position when the bowstring is released from its drawn position. Accordingly, the release of the bowstring causes the nock to be illuminated. A detent system resists movement of the switch member between the on and off positions.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, perspective view of a nock assembly.

FIG. 2 is a schematic, side view of the nock assembly.

FIG. 3 is a schematic, sectional, top view of the nock assembly.

FIG. 4 is a schematic, cutaway side view of the nock assembly.

FIG. 5 is a schematic, cross-sectional, front view of the nock assembly.

FIG. 6 is a schematic, cross-sectional, top view of the nock assembly with an actuator member in a first position.

FIG. 7 is a schematic, cross-sectional, top view of the nock assembly with the actuator member in a second position.

FIG. 8 is a schematic, cross-sectional, top view of the nock assembly illustrating a method for moving the actuator member from the second position to the first position.

FIG. 9 is a schematic, perspective view of the actuator member.

FIG. 10 is another schematic, perspective view of the actuator member.

FIG. 11 is a schematic, top view of the actuator member.

FIG. 12 is a schematic, side view of the actuator member.

FIG. 13 is a schematic, front view of the actuator member.

FIG. 14 is a schematic, cross-sectional, bottom view of the actuator member.

FIG. 15 is a schematic, perspective view of the nock assembly.

FIG. 16 is a schematic view of a detent assembly when the actuator member is in the first position.

FIG. 17 is a schematic view of the detent assembly when the actuator member is in the second position.

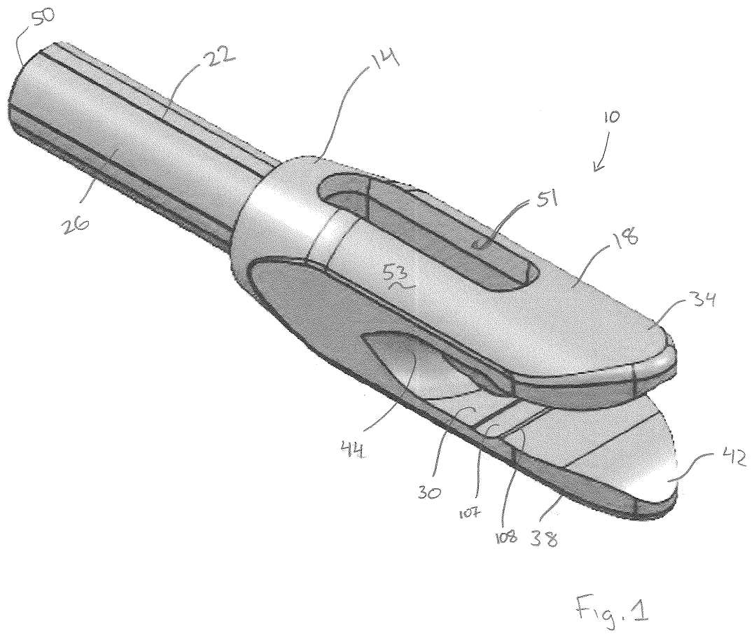

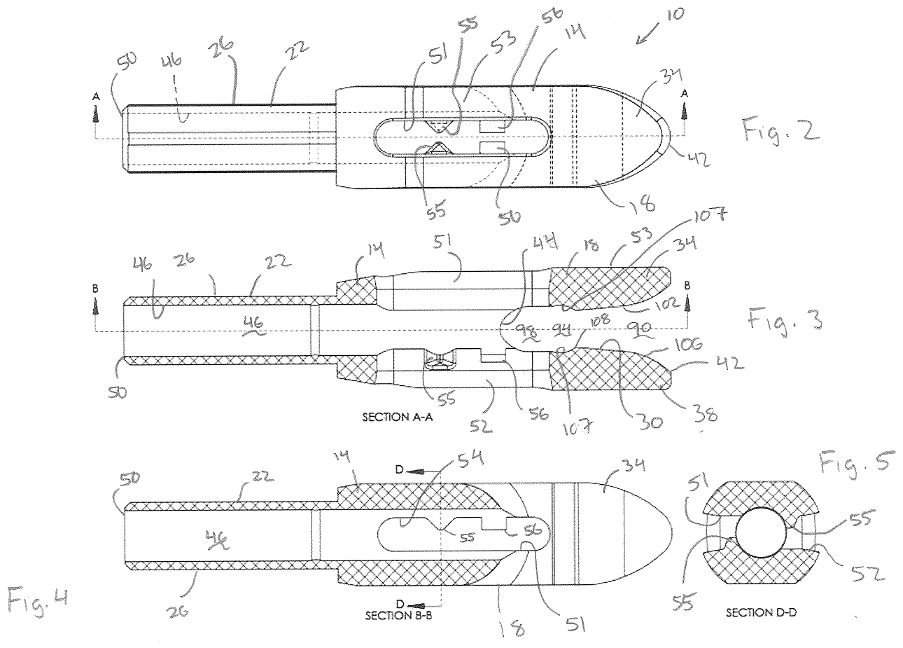

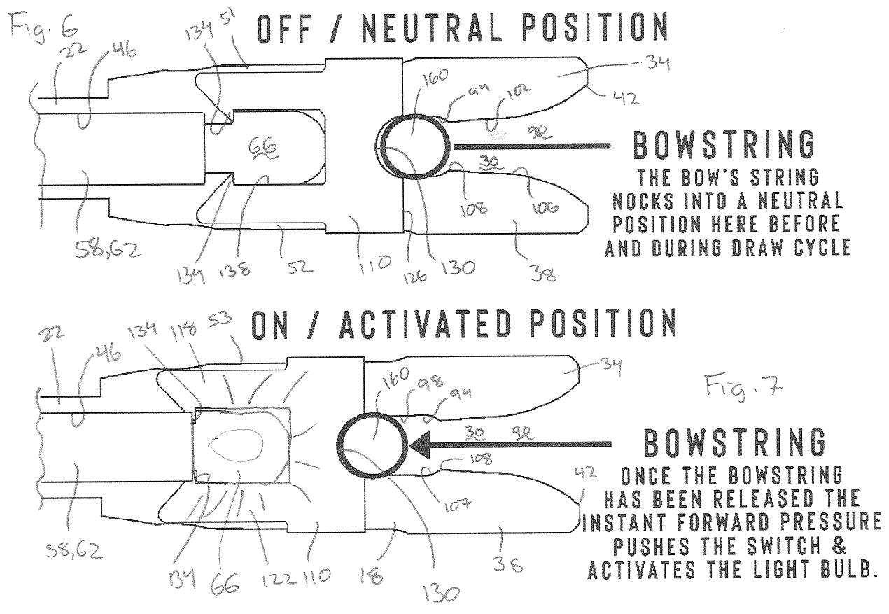

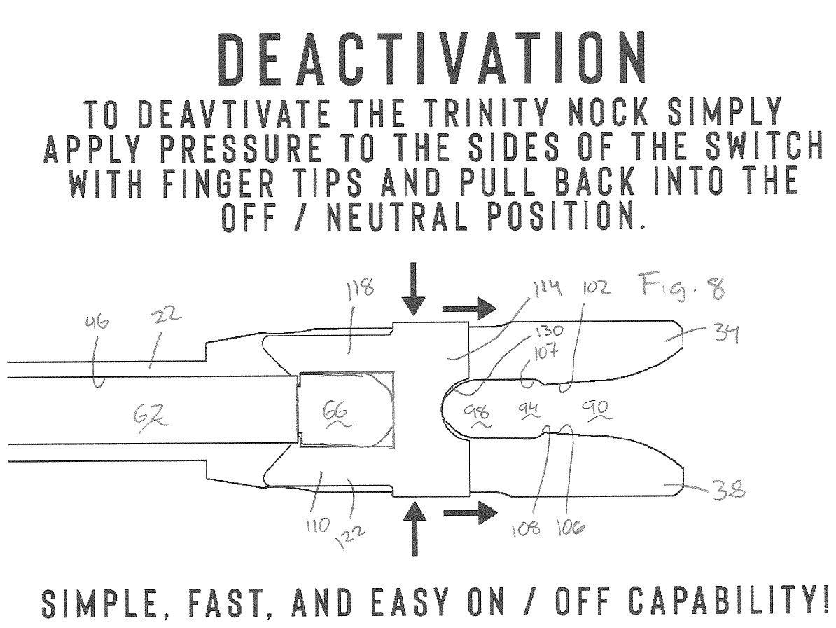

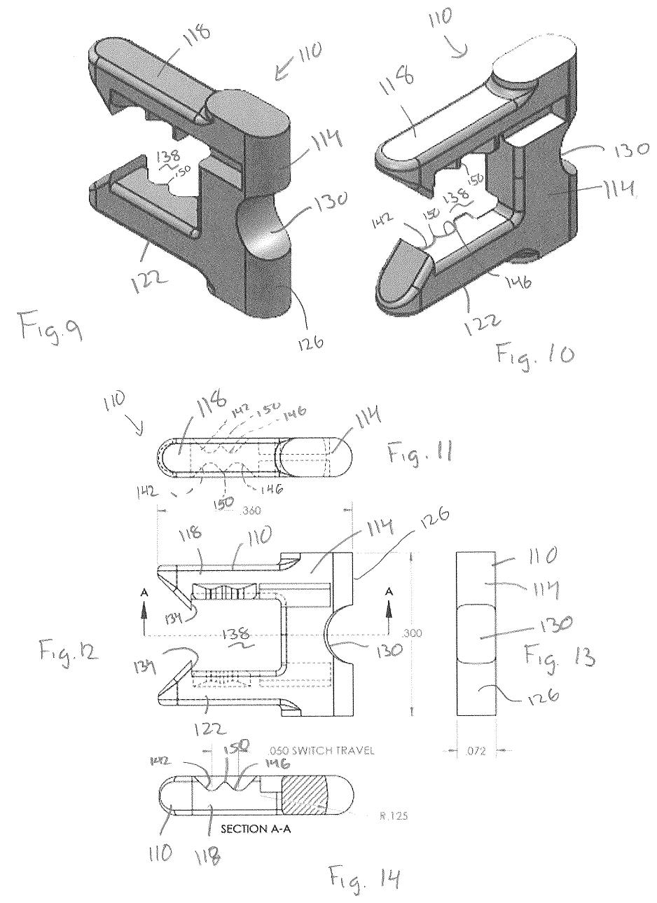

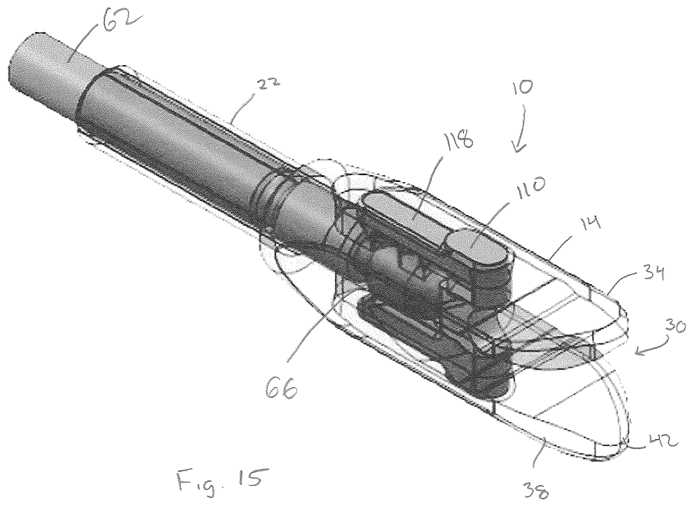

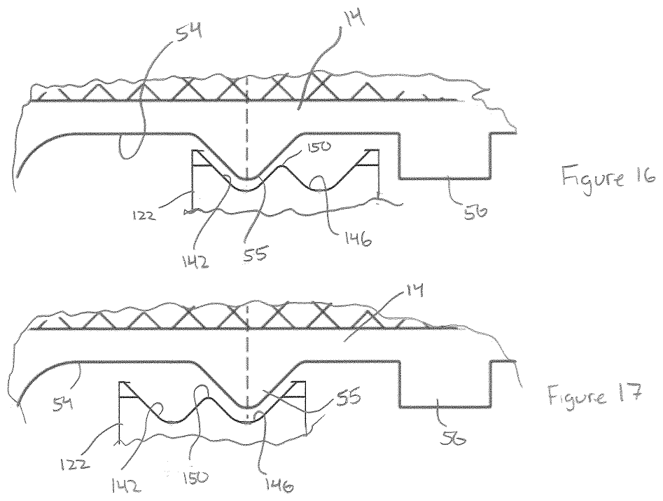

### DETAILED DESCRIPTION

Referring to the Figures, wherein like reference numbers refer to like components throughout, a nock assembly 10 is schematically depicted. The nock assembly 10 includes a nock member or body 14 having a nock portion 18 and a stem portion 22. The body 14 may be formed of a single piece of material as shown, or may comprise multiple pieces of material operatively interconnected to form a body 14 within the scope of the claimed invention. The stem portion 22 has an outer surface 26 matable with an arrow or crossbow bolt shaft. It should be noted that “arrow” and “crossbow bolt” may be used interchangeably herein. Similarly, the terms “bow” and “crossbow” may be used interchangeably herein. The nock portion 18 defines a notch 30. More specifically, the nock portion 18 includes two substantially parallel arms 34, 38 that define the notch 30 therebetween. The notch 30 has an opening 42 at one end for insertion of a bowstring, and terminates at an end 44 opposite the opening 42.

The nock body 14 defines a bore 46 extending from one end 50 of the nock member 14 to the notch 30. More specifically, the bore 46 extends through the terminal end 44 of the notch 30 such that the bore 46 is contiguous with the notch 30. The nock body 14 also defines two slots 51, 52 that extend from the outer surface 53 of the nock body 14 to the bore 46 and notch 30. Each slot 51, 52 is defined by a respective surface 54 that is characterized by two protuberances 55, 56. Protuberances 55 are characterized by sloped surfaces.

The nock assembly 10 also includes a light device 58, which includes a battery 62 and a light emitting device, which, in the embodiment depicted, is light-emitting diode 66 but could, for example, be an incandescent lamp within the scope of the claimed invention. The light device 58 includes a circuit operatively interconnecting the battery 62, the light-emitting diode 66, and a switch member. The switch member is movable to selectively open and close the circuit and thereby selectively turn the light-emitting diode 66 on and off. In the embodiment depicted, the switch member is the light-emitting diode 66 but could be a separate member within the scope of the claimed invention. More specifically, the light-emitting diode 66 is movable relative to the battery 62 and the nock body 14 between an off position, as shown in FIG. 6, and an on position, as shown in FIG. 7.

The light device 58 is configured such that the circuit is closed when the light-emitting diode 66 is in the on position and the circuit is open when the light-emitting diode 66 is in the off position. Accordingly, the light-emitting diode 66 receives electrical energy from the battery 62 and thereby produces visible light when the light-emitting diode is in the on position; the light emitting diode 66 is electrically disconnected from the battery 62, and thus does not emit light, when the light-emitting diode 66 is in the off position.

The light device 58 is connected to the nock member 14 such that the battery 62 is at least partially disposed within the bore 46. In the embodiment depicted, the battery 62 is retained within the bore 46 with adhesive, though other techniques for retaining the battery 62 within the bore 46 may be employed within the scope of the claimed invention. The light emitting diode 66 is also in the bore 46 and is movable from the first position, as shown in FIG. 6, to the second position, as shown in FIG. 7, by moving the light emitting diode 66 away from the opening 42.

The arms 34, 38 are configured such that the notch 30 is characterized by three segments, namely, a first segment 90, a second segment 94, and a third segment 98. Arm 34 defines surface 102 and arm 38 defines surface 106. Surfaces 102, 106 define the first segment 90 therebetween and are angled relative to one another such that the first segment 90 is widest at the opening 42 to the notch 30 and gets narrower with proximity to the second segment 94. At the second segment 94, surfaces 102, 106 are arcs 107. The width of the notch 30 is smallest at the intersection between the first segment 90 and the second segment 94, where a lip 108 is formed. In the third segment 98, the surfaces 102, 106 are substantially parallel to one another. The terminal end 44 is adjacent the third segment 98.

The nock assembly 10 further includes an actuator member 110. Actuator member 110 includes a main body portion 114 and two parallel arms 118, 122 extending therefrom. Each arm 118, 122 is disposed within a respective one of the slots 51, 52, and main body portion 114 extends through the bore 46 and the notch 30. Surface 126 of the main body portion 114 includes a semi-cylindrical concavity 130.

Each arm 118, 122 terminates in a respective hook 134. The arms 118, 122 and the main body portion 114 cooperate to define a cavity 138. The light-emitting diode 66 is positioned within the cavity 138, and the hooks 134 retain the light-emitting diode 66 within the cavity 138 such that the light-emitting diode 66 and the actuator member 110 are connected for unitary movement. Each of the arms 118, 122 extends into a respective one of the slots 51, 52, which limits movement of the arms 118, 122 to linear translation within the slots 51, 52. Accordingly, relative movement of the actuator member 110 with respect to the nock body 14 is limited to linear translation.

When the light emitting diode 66 is in the off position, the actuator member 110 is in a first position, as shown in FIG. 6. When the light emitting diode is in the on position, the actuator member is in a second position, as shown in FIG. 7. Each arm 118, 122 defines two concavities 142, 146 separated by a sloped protuberance 150. When the LED 66 is in the off position, and the actuator member 110 is in the first position, the protuberances 55 of the nock body 14 extend into a respective one of the cavities 142, as shown in FIG. 16. When the LED 66 is in the on position, and the actuator member 110 is in the second position, the protuberances 55 of the nock body 14 extend into a respective one of the cavities 146, as shown in FIG. 17.

Movement of the actuator member 110 between the first and second positions is resisted by physical part interference between the protuberance 55 and the protuberance 150. More specifically, the protuberance 55 contacts the protuberance 150, thereby preventing movement of the actuator member 110 between the first and second positions unless sufficient force is applied to the actuator member to cause either the actuator member 110 or the nock body 14, or both, to elastically deflect to enable the protuberance 150 to traverse the protuberance 55. The protuberances 55, 150 thus form a detent system.

As shown in FIG. 6, when the LED 66 is in the off position, the concavity 130 is within the notch 30 and cooperates with the arcs 107 formed in surfaces 102, 106 to capture a bowstring 160. The bowstring 160 is retained within the arcs 107 and concavity 130 while the bowstring is drawn by an archer. Referring to FIG. 7, when the bowstring 160 is released from its drawn or cocked position, the bowstring 160 exerts sufficient force on the actuator member 110 to overcome the resistance of the detent system, and the actuator member moves from its first position to its second position.

Movement of the actuator member 110 from the first position to the second position causes movement of the LED 66 from its off position to its on position. Accordingly, releasing the bowstring 160 causes the LED to illuminate, enabling an archer to observe the flight of the arrow to which the nock assembly 10 is attached, and to assist in tracking any game that may have been hit by the arrow.

Referring to FIG. 8, an archer may deactivate the LED 66 by moving the actuator member 110 to the first position. This is accomplished by exerting sufficient force on the actuator member 110 to cause the protuberances 150 to disengage from the protuberances 55, and then sliding the actuator member 110.

While the best modes for carrying out the disclosure have been described in detail, those familiar with the art to which this disclosure relates will recognize various alternative designs and embodiments for practicing the disclosure within the scope of the appended claims.

1. A nock assembly for engagement with a bow or crossbow having a bowstring, the nock assembly comprising:
a nock body having a first arm having a first surface and a second arm generally parallel to the first arm and having a second surface;
said first and second surfaces defining a notch therebetween;
said notch having a first end and a second end, wherein the first arm and the second arm cooperate to define an opening to the notch through which the bowstring is insertable into the notch at the first end;
a light assembly configured to selectively emit light and including a switch member that is movable relative to the nock body between an on position and an off position, wherein
the light assembly is configured such that the light assembly does not emit light when the switch member is in the off position, and the light assembly emits light when the switch member is in the on position, and
the switch member in the on position is further from the opening than the switch member in the off position;
an actuator member operatively connected to the switch member for unitary movement therewith, the actuator member being in a first position relative to the nock body when the switch member is in the off position, and the actuator member being in a second position relative to the nock body when the switch member is in the on position; and
a detent system that resists movement of the actuator member between the first and second positions, and thus resists movement of the switch member between the on and off positions,
wherein the actuator member extends across the notch when the actuator member is in the first position such that, when the bowstring is within the notch and released from its cocked or drawn position, the bowstring exerts sufficient force on the actuator member to overcome the resistance of the detent system and cause the actuator member to move from the first position to the second position, which in turn causes the switch member to move from the off position to the on position.

2. The nock assembly of claim 1, wherein
the light assembly includes a battery and a light emitting diode operatively connected to the battery, and
the light emitting diode forms at least a portion of the switch member.

3. The nock assembly of claim 2, wherein
the nock body defines a first protuberance,
the actuator member defines a second protuberance, and
the first and second protuberances are positioned such that physical part interference between the first and second protuberances resists movement of the actuator member between the first and second positions.

4. The nock assembly of claim 3, wherein the nock body and/or the actuator member deforms sufficiently to enable the second protuberance to traverse across the first protuberance when sufficient force is applied to the actuator member, thereby permitting movement of the actuator member from the first position to the second position.

5. The nock assembly of claim 4, wherein
the actuator member includes two arms each having a respective hook at their ends, and
the light emitting diode is retained between the two arms by the hooks.

6. The nock assembly of claim 5, wherein
the nock body defines a lip within the notch, and
the actuator member defines a concavity positioned such that the bowstring is between the lip and extends into the cavity when the bowstring is sufficiently inserted into the notch.

7. A nock assembly for engagement with a bow or crossbow having a bowstring, the nock assembly comprising:
a nock body defining a nock;
a light assembly configured to selectively emit light, the light assembly including a switch member that is movable relative to the nock body between an on position and an off position, the light assembly not emitting light when the switch member is in the off position, the light assembly emitting light when the switch member is in the on position;
an actuator member operatively connected to the switch member for unitary movement therewith; and
a detent system that resists movement of the actuator member so as to resist movement of the switch member between the on and off positions,
wherein the actuator member moveably extends across the notch such that, when the bowstring is within the notch and released from a cocked or drawn position, the bowstring exerts sufficient force on the actuator member to overcome the resistance of the detent system to move the actuator member, which in turn causes the switch member to move from the off position to the on position.
